(19) United States
(12) Patent Application Publication
(10) Pub. No.: US 2007/0084977 A1
(43) Pub. Date: Apr. 19, 2007

(54) Model car display

(76) Inventors: Darrell Scott Hall, Paradise, PA (US); Tina M. Hall, Paradise, PA (US)

Correspondence Address: Darrel Scott Hall, 274 South Vintage Road, Paradise, PA, 17562-9740, US

(21) Appl. No.: 11/581,994

(22) Filed: Oct. 17, 2006

Related U.S. Application Data
(60) Provisional application No. 60/727,374, filed on Oct. 17, 2005.

(51) Int. Cl. F16M 11/00

(52) U.S. Cl. 248/125.7

(57) ABSTRACT

The present invention overcomes any current limitations of model displaying technology by offering a wall mountable device which may pivot at a wall mount point and may also pivot and rotate at an adjustable model mount point.

### CROSS REFERENCE TO RELATED APPLICATION

This application claims priority from U.S. provisional application no. 06/727,374 which was filed on Oct. 17, 2005 which is incorporated by reference as if fully set forth.

### BACKGROUND OF THE INVENTION

A model is a valued asset to the hobbyist or collector and it is important to these people to keep their collections of model cars, airplanes, rockets or boats out of harm's way. One such way is to have the models fastidiously packed inside of boxes and then tucking them away in a closet, attic or basement. But, to the emotional collector or enthusiast, it is just as important to display his or her prize model. If the collector opts to store their model, they can and often do develop empty feelings from not being able to enjoy their prize model. This can be very disheartening for the collector if he assembled it or if it is a specially purchased special edition scale model.

The collector places the model in jeopardy by displaying it on a shelf or desktop where it is susceptible to accidental damage. In addition, the model on the shelf will collect dust and bugs and must be physically moved to clean underneath it. This movement also increases the risk of damage to the model.

Instead of a shelf, the collector may suspend or hang the model from a ceiling with fishing line or wire. This approach eliminates dusting underneath the model, but only has a modicum of success with model planes. Like real airplanes, model planes have hardpoints. A hardpoint is a secure and safe location to attach things to, such as fishing line or wire. Another problem with ceiling mounting is the shape of the models. For example, if the collector wants to hang a car, they must locate a safe and secure place on the car to attach the wire. The collector must also synchronize and transfer the mounting pattern to the ceiling. If the transfer is incorrect, wires may be crossed or crooked.

Clearly, the above demonstrates a need for a new model display that allows a collector to proudly and easily display his or her models in a safe and secure way. It is also desirable to see the model from many positions and have the ability to dust the model with a feather duster or a blast of compressed air to eliminate any accumulated dust or insects. In addition, the mounting device should be easy to install to a wall and be easily modifiable for many models. None of the above current displaying methodologies alone, or combined, offer the collector the simplicity, versatility or “innovativeness”’ as suggested by the current invention.

### SUMMARY OF THE INVENTION

The present invention overcomes any current limitations of model displaying technology by offering a wall mountable device which may pivot at a wall mount point and may also pivot at an adjustable model mount point.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is a further object of the present invention to provide a new display shelf unit which is of a durable, reliable and attractive construction and easier to install than the prior art.

### BRIEF DESCRIPTION OF THE DRAWING

FIG. 1 is a graphic representation showing a wall mount, a pivotal arm, a mini pivotal arm and a rotatable universal model mount which represents an embodiment of the present invention.

FIG. 2 is a graphic representation showing a wall mount, a pivotal arm, a mini pivotal arm and a notched longitudinal rotatable universal model mount which represents another embodiment of the present invention.

### DETAILED DESCRIPTION OF THE PREFERRED EMBODIMENT(S)

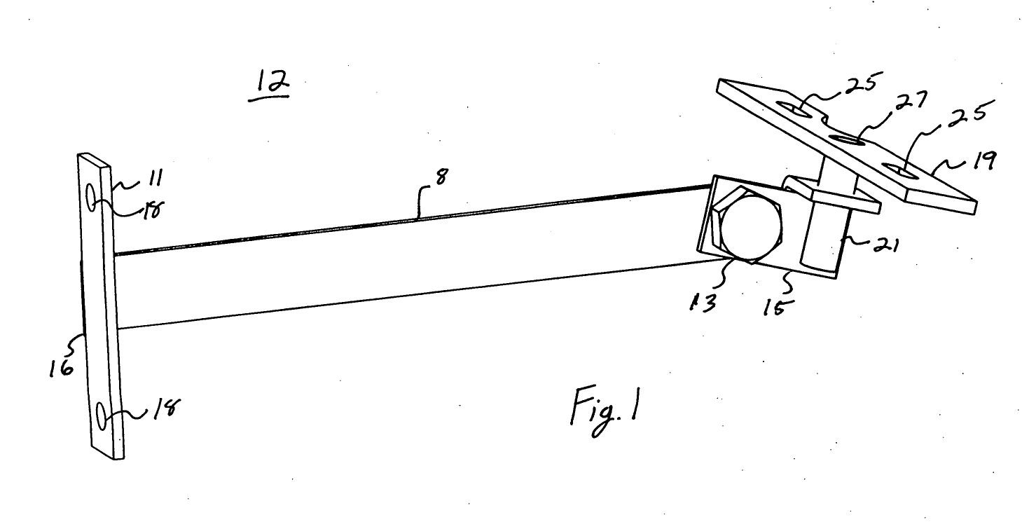

With reference now to the drawing FIG. 1, a narrow mount embodiment 12 of the present invention is shown. A wall mount 11 is attached to a first longitudinal arm 8 by a weld 16 forming an assembly. Alternatively, the wall mount 11 may be manufactured to the first longitudinal arm 8 forming an assembly. The wall mount 11 has mounting holes 18 which affixes the assembly to a vertical surface such as a wall. A pivotal arm 15 is attached to the first longitudinal arm 8 by an adjustable fastener 13, for example a bolt. A narrow mount 19 is attached to the pivotal arm 15 by utilizing an adjustable multithread device 21. The adjustable multithread device 21 may be welded to the narrow mount 19 or it may be produced as a complete assembly when it is manufactured. The narrow mount 19 has mounting holes 19 for attaching to a model.

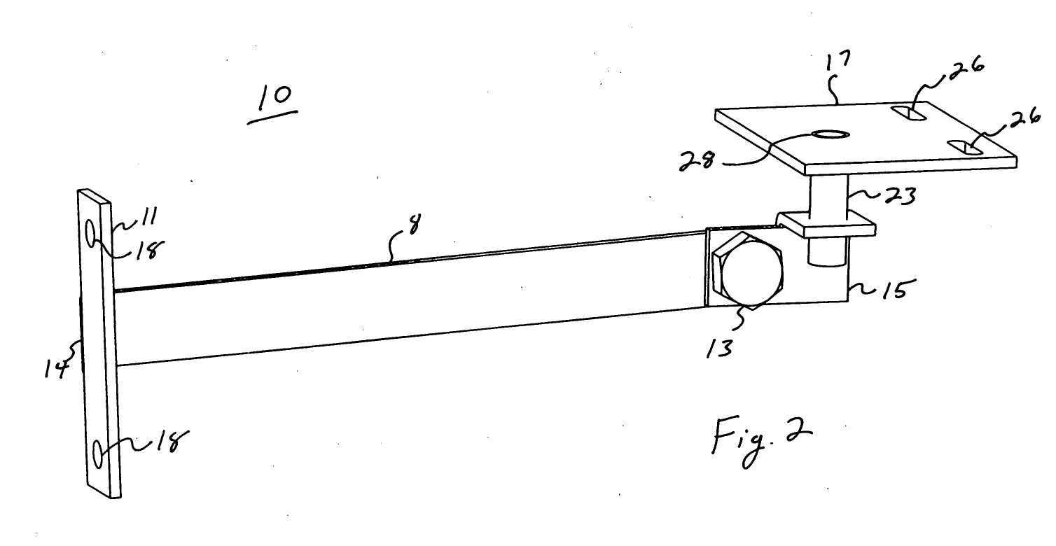

With reference now to the drawing FIG. 2, a rectangular mount embodiment 10 of the present invention is shown. A wall mount 11 is attached to a first longitudinal arm 8 by a weld 14 forming an assembly. Alternatively, the wall mount 11 may be manufactured to the first longitudinal arm 8 forming an assembly. The wall mount 11 has mounting holes 18 which affixes the assembly to a vertical surface such as a wall. A pivotal arm 15 is attached to the first longitudinal arm 8 by an adjustable fastener 13, for example a bolt. A rectangular mount 17 is attached to the pivotal arm 15 by utilizing an adjustable multithread device 23. The adjustable multithread device 23 may be welded to the rectangular mount 17 or it may be produced as a complete assembly when manufactured. The rectangular mount 17 has mounting holes 26 for attaching to a model.

An advantage of any embodiments is that it allows the owner of models can securely and proudly display their models. The display can be made out of aluminum, brass, wood, plastic or any malleable material and can be formed into the desired parts.

As to a further discussion of the manner of the usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, color, weight, materials, shape, form, function and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be restored to, falling within the scope of the invention.

What is claimed is:

1. A mountable display for models, comprising:
a wall mount which is attached to a first longitudinal arm, and said first longitudinal arm is pivotally attached to a pivotal arm,
a model mount is attached to said pivotal arm, and has at least one mounting location to affix a model to said model mount.

2. The mountable display for models in claim 1, wherein said model mount is a rectangle shape to match the shape of the model to be displayed.

3. The mountable display for models in claim 1, wherein said wall mount and said first longitudinal arm are permanently affixed.

4. The mountable display for models in claim 1, wherein said wall mount and said first longitudinal arm are user attachable and detachable.

5. The mountable display for models in claim 1, wherein at least one of a plethora of mounting hole(s) is available to attach said wall mount to a vertical or horizontal surface.

6. The mountable display for models in claim 1, wherein the first longitudinal arm is variably attached to said pivotal arm.

7. The mountable display for model vehicles in claim 1, wherein a pivotal arm which is attached to the first longitudinal arm by at least one adjustable fastener it at least one of a plethora of locations.

8. The mountable display for model vehicles in claim 1, wherein said model is attached to said model mount in at least one of a plethora of mounting points.

9. The mountable display for model vehicles in claim 1, wherein said model mount is variable and adjustably attached to said pivotal arm.

10. The mountable display for model vehicles in claim 1, wherein said model mount is in a shape is conducive for the desired model.

11. A method for mounting and displaying models comprising:
attaching a wall mount to a first longitudinal arm and said first longitudinal arm is pivotally attached to a pivotal arm, and
attaching a model mount to said pivotal arm with at least one mounting location to affix a model.

12. The method mounting and displaying models in claim 1, further comprising:
providing at least one of plethora of mounting devices in which to attach said wall mount to a surface.

13. The method mounting and displaying models in claim 1, further comprising:
affixing said wall mount and said first longitudinal arm via a permanent means.

14. The method mounting and displaying models in claim 1, further comprising:
attaching said wall mount and said first longitudinal semi-permanently by a user.

15. The method mounting and displaying models in claim 1, further comprising:
providing at least one of a plethora of mounting hole(s) to attach said wall mount to a vertical or horizontal surface.

16. The method mounting and displaying models in claim 1, further comprising:
attaching the first longitudinal arm to said pivotal arm with a variable means.

17. The method mounting and displaying models in claim 1, further comprising:
adjusting said pivotal arm to the first longitudinal arm by an adjustable fastener(s) it at least one place.

18. The method mounting and displaying models in claim 1, further comprising:
attaching said model mount in at least one of a plethora of mounting points.

19. The method mounting and displaying models in claim 1, further comprising:
adjusting said model mount by variably regulating said pivotal arm into a plethora of positions and affixing a stop mechanism.

20. The method mounting and displaying models in claim 1, further comprising:
choosing a model mount shape to be conducive for the desired model.
